(19) United States
(12) Patent Application Publication
(10) Pub. No.: US 2022/0009045 A1
(43) Pub. Date: Jan. 13, 2022

(54) MORTISER

(71) Applicant: NAP ASSET HOLDINGS LTD., Wilmington, DE (US)

(72) Inventor: Philippe TURCOT, Marieville (CA)

(21) Appl. No.: 17/367,966

(22) Filed: Jul. 6, 2021

Related U.S. Application Data
(60) Provisional application No. 63/049,774, filed on Jul. 9, 2020.

(51) Int. Cl. B23Q 11/00; B27F 5/12

(52) U.S. Cl. CPC B23Q 11/005; B27F 5/12

(57) ABSTRACT

A mortiser comprises a double spindle head having an input spindle drivingly connectable to a spindle of a CNC machine. The head has a pair of output spindles drivingly connected to the input spindle and spaced-apart along a feed axis X. A pair of mandrels are drivingly connected to the output spindles. Router bits are mounted at a distal end of the mandrels. A frame member is disposed between the pair of mandrels. The frame member provides support to the pair of mandrels along the feed axis X.

### RELATED APPLICATION

This application claims priority from U.S. Provisional Patent Application No. 63/049,774 filed Jul. 9, 2020, the entire contents of which are incorporated by reference herein.

### TECHNICAL FIELD

The disclosure relates generally to cutting tools and, more particularly, to systems and methods suitable for cutting mortises or slots in materials, such as wood plastic, and non-ferrous metals.

### BACKGROUND OF THE ART

Chain mortisers with HSS tips are typically used to cut deep mortise in timber frame construction. However, such chain mortisers require a lot of maintenance, which may lead to production downtime.

There is a continued need for improving productivity while maintaining quality cuts. Alternatives to know techniques are, thus, desirable.

### SUMMARY

In one aspect, there is provided a double head mortising unit comprising a pair of cutting tools (e.g. router bits) mounted at a distal end of a pair of parallel mandrels supported in a fixed laterally spaced-apart relationship by a central frame member.

In accordance with another aspect, the central frame member is a hollow frame member fluidly connected to a collection dust system, the hollow frame member having a distal end defining a dust collector opening between the cutting tools.

In accordance with a further aspect, the mandrels are supported on bearings mounted on opposed longitudinal sides of the frame member.

In accordance with a still further aspect, one or more nozzles are provided at a distal end of the frame member, the nozzles being connected to a source of pressurized air.

### DESCRIPTION OF THE DRAWINGS

Reference is now made to the accompanying figures in which:

FIG. 1 is an isometric view of an exemplary horizontal double head router bit mortising unit configured to be mounted to a computer numerical control (CNC) machine for cutting mortises and slots in materials, such as wood, plastic and non-ferrous metals.

FIG. 2 is an isometric view of an exemplary vertical double head router bit mortising unit configured to be mounted to a CNC machine.

FIGS. 3a-3c are isometric views of exemplary cuts that can be realised in a workpiece with the mortising units shown in FIGS. 1 and 2.

### DETAILED DESCRIPTION

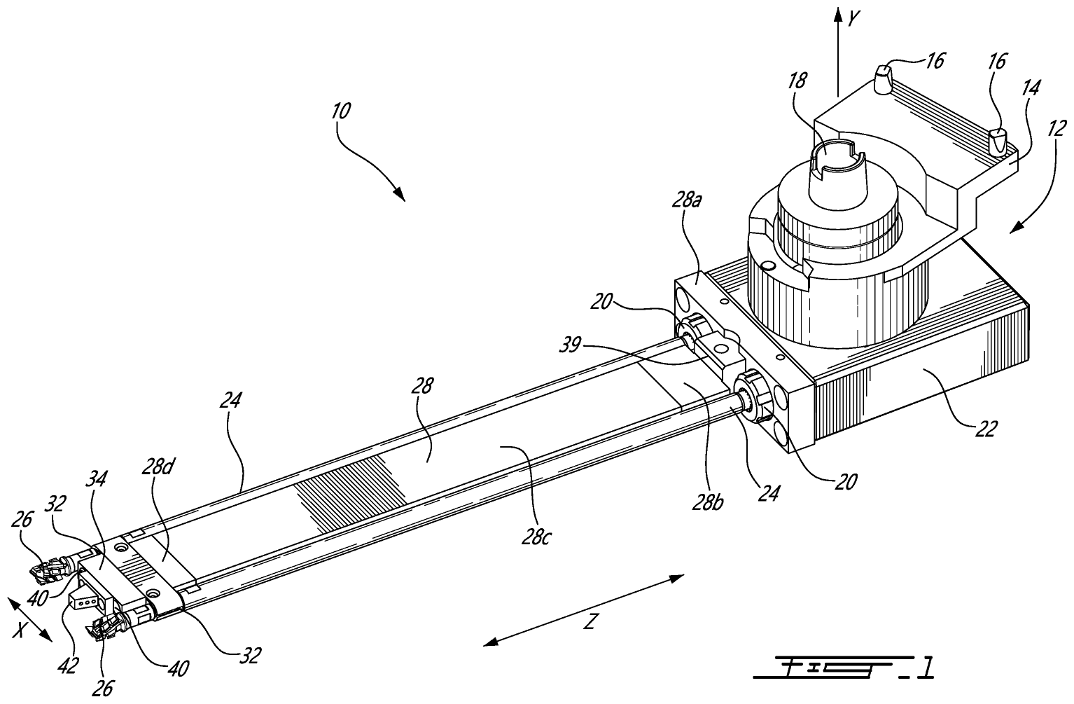

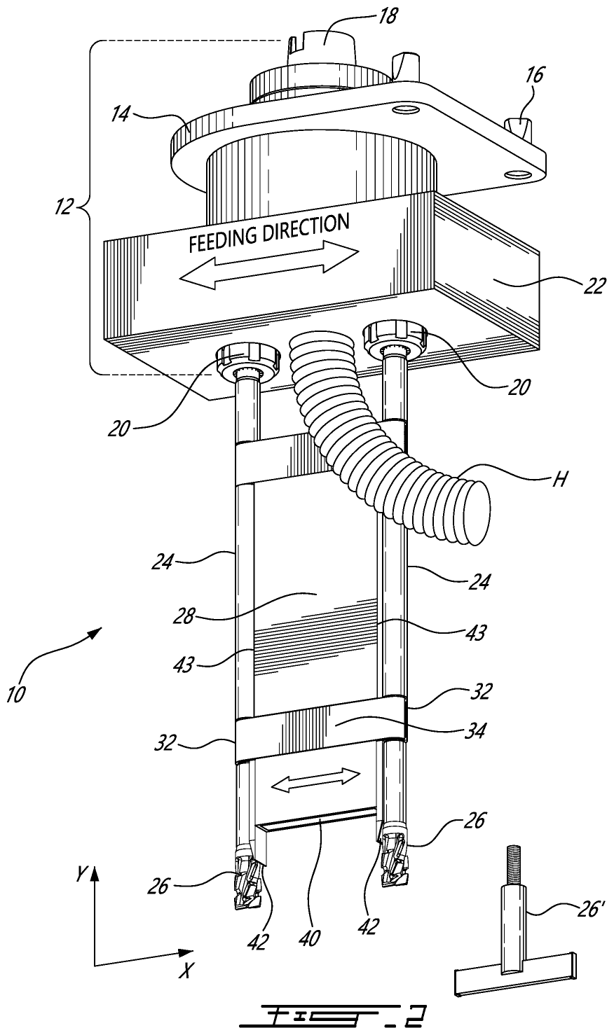

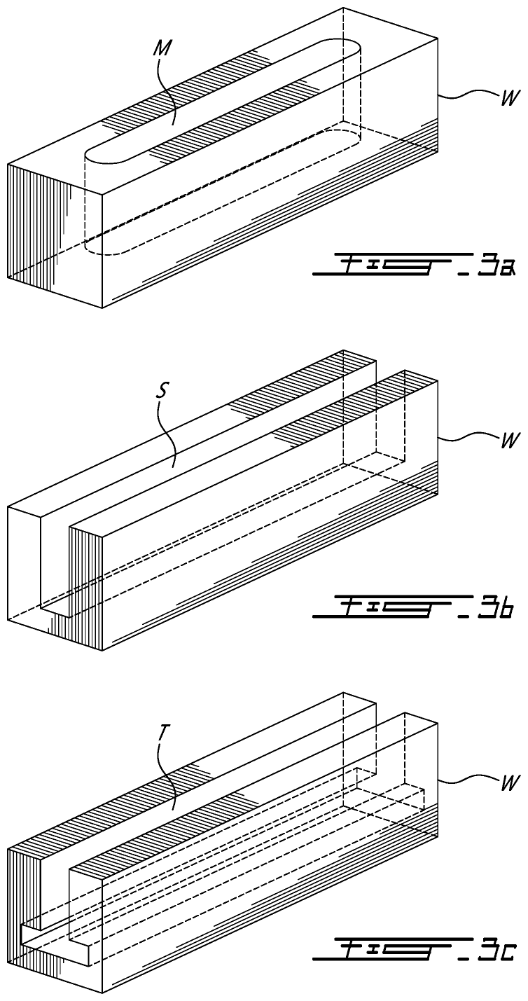

FIG. 1 illustrates an embodiment of a double cutting tool head unit 10 configured to be installed on a CNC machine center (not shown) to form a horizontal mortiser. FIG. 2, shows another embodiment in which the unit is this time configured to form a vertical mortiser. As will be seen hereinafter, in both its vertical and horizontal configurations, the double cutting tool head unit 10 is well suited for cutting a deep elongated mortise M (FIG. 3a) or a slot S (FIG. 3b) in a workpiece W made of wood (e.g. glue lam trusses), plastic or non-ferrous metals. For instance, it could be used to cut 5 to 20 inches deep mortises or slots. The unit 10 can also be equipped with profiled cutting tools for cutting profiled slots (e.g. inverted T-shaped slot T in FIG. 3c).

Now referring back to the embodiment of FIG. 1, it can be appreciated that exemplary unit 10 comprises a tool holder, also known as an aggregate 12 configured to be mounted to the main spindle of the CNC machine. According to the illustrated embodiment, the tool holder/aggregate 12 is provided in the form of a multi-spindle head. The multi-spindle head has a machine interface component 14 adapted to be fixedly mounted to the body of the CNC machine. Pins 16 or the like may be provided on the machine interface component 14 for engagement in corresponding holes in the body of the machine so as to lock the machine interface component 14 against rotation relative to the body of the CNC machine. It is understood that various connections can be used to attach the aggregate 12 to the CNC machine, the illustrated interface component being only one possible example.

The illustrated multi-spindle head has a top central input spindle 18 adapted to be drivingly connected to the main spindle of the CNC machine. The central input spindle 18 is, in turn, drivingly connected to a pair of side-by-side output spindles 20 via a gear system 22 housed in a gearbox housing mounted to a bottom face of the machine interface component 14. The gear system 22 may be configured to drive the two output spindles 20 in a same direction or in opposite directions depending on the intended application.

According to the embodiment shown in FIG. 1, the input spindle 18 is at right angle to the output spindles 20. More particularly, the input spindle 18 extends along a vertical axis Y normal to the X-Z plane (horizontal plane), whereas the output spindles 20 extend along the Z direction (i.e. a direction normal to the X-Y plane). The output spindles 20 are vertically aligned (the have the same Y coordinate) and laterally spaced-apart along the X axis by a predetermined distance. For instance, according to one possible application, the center of the output spindles 20 are spaced-apart by 3 inches along the X axis.

The output spindles 20 are drivingly connected to respective elongated mandrels 24 extending longitudinally along the Z direction (i.e. the plunging direction of the tool). In that regards, the output spindles 20 may be provided with adjustable connectors/adaptors, such as ER-20 collets, for removable connection with different sizes of mandrels. A replaceable cutting tool 26 is detachably mounted to the distal end of each mandrel 24. For instance, as shown in FIG. 1, the cutting tool 26 can be provided in the form of a router bit having long lasting diamond cutting edges. Such diamond cutting tools are low maintenance and can allow for higher productivity as compared to conventional mortising chain units. According to one exemplary embodiment, the router bits have a cutting diameter of about 7-8 mm. The cutting tools (e.g. router bits) can be mounted to the distal end of the mandrels 24 via a threaded connection. For instance, an axially extending threaded hole can be defined in the distal end of each mandrel 24 for threadably receiving a corresponding externally threaded shank portion (FIG. 2) of the cutting tool 26. As shown in FIG. 2, the cutting tools 26 can be provided in the form profiled cutting tools 26′ configured to cut a desired profiled slots, an inverted-T shaped slot (FIG. 3c) in the illustrated example.

Still referring to FIG. 1, it can be appreciated that the mortising unit 10 further comprises a mandrel support or central frame member 28 extending longitudinally along the Z axis between the two mandrels 24. The central frame member 28 has a mounting plate 28a securely mounted to the structure of aggregate 12. As can be appreciated from FIG. 1, the mounting plate 28a is configured to accommodate the two output spindles 20. Fasteners, such a bolts and the like, can be used to detachably mount the mounting plate 28a of the central frame member 28 to the structure of the aggregate 12. The central frame member 28 can be segmented or of unitary construction. According to the embodiment shown in FIG. 1, the frame member 28 is segmented and comprise a proximal end portion (or base) 28b extending integrally from the mounting plate 28a, a main intermediate portion 28c mounted to the proximal end portion 28b and a distal end portion 28d mounted to the main intermediate portion 28c.

The frame member 28 provides support to the elongated mandrels 24. Notably, the frame member 28 is configured to support the mandrels 24 along the X axis to prevent the same from flexing when the double-headed unit 10 is displaced along a feeding direction corresponding to the X axis during cutting. As shown in FIG. 1, a pair of bearings 32 are mounted to opposed sides of the distal end portion 28d of the frame member 28 for providing support to the mandrels 24 adjacent to the cutting tools 26. A bearing cage 34 is used to laterally mount the bearings on opposed sides of the central frame member 28. According to an embodiment, the bearings 32 are ball bearings. However, it is understood that other bearings suitable for supporting high speed rotating shafts and support flexural loading of the mandrels 24 could be used. The bearings 32 are disposed adjacent to the cutting tools 26 along the Z axis to support the distal end portion of the mandrels 24. The frame member 28 and the bearings 32 carried thereby are configured to resist the loads transferred to the mandrels 24 along the X axis as the unit 10 is displaced along the X axis while cutting a mortise or a slot in a workpiece. That is the central frame member 28 provides added rigidity along the X axis for the two interconnected mandrels 24, thereby allowing feeding movement along the X axis in rigid materials such as wood, plastic and non-ferrous metals.

The frame member 28 and the bearings 32 also provide to some degree support to the mandrels 24 along the Y axis, thereby allowing some degree of movement along the Y axis during cutting. However, the main structural role of frame member 28 is to provide mandrel rigidity along the X axis.

In accordance with a particular embodiment, in addition to its structural role, the central frame member 28 has a second function, namely a dust collection function (e.g. extraction of wood chips) to extract sawdust from the mortise or slot as the same is being cut by the cutting tools 26 (e.g. router bits). As shown in FIG. 1, the central frame member 28 can be provided in the form of a hollow frame member to act as a dust collection duct having a dust exhaust port 39 adapted to be connected to a dust collection hose H (FIG. 2) of a dust collection unit (not shown). The frame member 28 has a dust collection opening 40 defined in the distal end thereof between the two cutting tools 26. The dust collecting opening 40 is fluidly connected to the dust exhaust port 39 via the hollow body of the frame member 28. In operation, sawdust is sucked through the dust collection opening 40 directly at the mortise or slot being cut. The sawdust withdrawn through the dust collection opening 40 travels longitudinally in the hollow frame member 28 before being discharged via exhaust port 39. From port 39 the dust is directed into the dust collection system via the dust collection hose H (FIG. 2).

According to another aspect, one or more nozzles 42 can be integrated to the distal end of the frame member 28 immediately adjacent to an inboard side of the cutting tools 26 to direct air jets toward the cutting tools 26. The air nozzles 42 are connected to a source of pressurized air via suitable air hoses 43 (only shown in connection with the embodiment of FIG. 2) or the like. The air hoses can run along the inner or outer side of the frame member 28. Alternatively, the nozzles 42 can be fluidly connected to the source of air via the frame member 28. The source of pressurized air can be operatively connected to a valve that is, in turn, operatively connected to a control system for selectively feeding the air nozzles 42 with pressurized air when it is desired to dislodge wood chips and the like from the cutting tools 26. The control system can be programmed to provide pressurized air to the nozzles 42 at selected intervals in a pulse fashion or, alternatively, in a continuous fashion.

In use, the CNC machine is programmed to first plunge the cutting tools 26 into the workpiece by a predetermined distance (e.g. 0.5 inches) in the Z direction. Then, the CNC machine moves the cutting tool in a first feed direction along the X axis. During the first phase of the movement along the X axis, the two cutting tools 26 (e.g. router bits) cut the workpiece. When the second cutting tool reaches the plunging location of the first cutting tool, then only the first cutting tool continues to cut the workpiece as the first and second cutting tools are displaced towards the end of their stroke along the first X feed direction. When the cutting tools 26 reach the end of their first stroke, then the CNC machine re-plunges the cutting tools 26 deeper into the workpiece and the CNC machine then displaces the cutting tools 26 in a second feed direction, opposite to the first direction, along the X axis. Again for the first part of this second opposite stroke, both cutting tools 26 cut into the workpiece. However, when the first cutting tool reaches the re-plugging location of the second cutting tool, then only the second cutting tool will cut into the workpiece for the rest of the second feeding stroke. These plunging (Z axis movements) and back and forth feeding movements (X axis movements) are repeated until the desired mortise/slot deepness and length is achieved.

FIG. 2 illustrates a second embodiment in which components similar to components of the first embodiment are designated by same reference numerals. A duplicate description of the similar components is herein omitted for brevity. The second embodiment, essentially differs from the first embodiment in that the aggregate 12 is configured to provide a vertical mortiser as opposed to the horizontal mortiser. According to this embodiment, the plunging direction is along the Y axis (i.e. the vertical axis) and the feeding direction is along the X axis. Still according to this embodiment, the two output spindles 20 extend in parallel to the top input spindle 18 that is along a direction parallel to vertical axis Y.

FIG. 2 also shows an inverted T-shaped profiled tool that can be removably mounted at the distal end of the mandrels for cutting a corresponding profiled slot in a workpiece W (see FIG. 3c).

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A mortiser comprising:
a double spindle head having an input spindle drivingly connectable to a spindle of a CNC machine, and a pair of output spindles drivingly connected to the input spindle and spaced-apart along a feed axis X of the mortiser;
a pair of mandrels drivingly connected to the pair of output spindles;
router bits mounted at respective distal ends of the mandrels; and
a frame member disposed between the pair of mandrels along the feed axis X, the frame member providing support to the pair of mandrels along the feed axis X.

2. The mortiser defined in claim 1, wherein the frame member is a hollow frame member defining a dust collection duct having a dust collection opening at a distal end thereof adjacent to the router bits.

3. The mortiser defined in claim 1, further comprising bearings mounted on opposed longitudinal sides of the frame member, the mandrels rotatably supported by the bearings.

4. The mortiser defined in claim 3, wherein the bearings are disposed adjacent to the router bits at the distal ends of the mandrels.

5. The mortiser defined in claim 2, wherein the frame member has a dust exhaust port connectable to a dust collection system.

6. The mortiser defined in claim 1, wherein one or more air nozzles are provided at a distal end portion of the frame member for directing air jets at the router bits.

7. The mortiser defined in claim 1, wherein the input spindle is perpendicular to the pair of output spindles and drivingly connected thereto via a gearbox.

8. The mortiser defined in claim 1, wherein the pair of mandrels are detachably drivingly connected to the pair of output spindles via adjustable connectors configurable to accommodate different sizes of mandrels.

9. The mortiser defined in claim 1, wherein the input spindle, the pair of output spindles and the pair of mandrels extend at right angles to the feed axis X.

10. The mortiser defined in claim 1, wherein the router bits are mounted to the distal end of the mandrels 24 via a threaded connection.

11. The mortiser defined in claim 10, wherein an axially extending threaded hole is defined in the distal end of each one of the mandrels for threadably receiving a corresponding externally threaded shank portion of an associated one of the router bits.

12. A double router bit mortising unit comprising:
a CNC tool holder having a machine interface component adapted to be mounted to a CNC machine, an input spindle adapted to be drivingly connected to the main spindle of the CNC machine, and a pair of output spindles drivingly connected to the input spindle via a gearbox, the output spindle being spaced-apart along a feed direction X;
a pair of mandrels drivingly connected to the output spindles;
a frame member bracing the pair of mandrels along the feed direction X;
a pair of bearings carried by the frame member for supporting the pair of mandrels;
router bits detachably mounted to respective distal ends of the mandrels; and
at least one nozzle mounted to the frame member between the router bits for directing air jets towards the router bits.

13. The double router bit mortising unit according to claim 12, wherein the input spindle is perpendicular to the a plane containing the pair of mandrels.

14. The double router bit mortising unit according to claim 12, wherein adjustable collets are provided to detachably connect the mandrels to the output spindles.

15. The double router bit mortising unit according to claim 12, wherein the frame member is hollow and fluidly connected to the at least one nozzle.

16. The double router bit mortising unit according to claim 12, wherein the router bits are threadably mounted to the distal ends of the mandrels.
